(19) United States
(12) Patent Application Publication
(10) Pub. No.: US 2019/0391790 A1
(43) Pub. Date: Dec. 26, 2019

(54) PRE-COMPILER, SYSTEM FOR DEVELOPING A PROGRAM, PRE-COMPILATION METHOD AND CORRESPONDING COMPUTER PROGRAM

(71) Applicant: BULL SAS, Les Clayes-sous-Bois (FR)

(72) Inventor: Daniel AVAKIANTZ, Buc (FR)

(21) Appl. No.: 16/453,279

(22) Filed: Jun. 26, 2019

(30) Foreign Application Priority Data
Jun. 26, 2018 (FR) 1855695

(51) Int. Cl. G06F 8/30; G06F 8/41

(52) U.S. Cl. CPC G06F 8/30; G06F 8/41

(57) ABSTRACT

A pre-compiler is arranged to analyze a source code including main code written in a main computer language and at least one block of code written in another computer language embedded in the main code, and replace each block of embedded code by replacement code in the main computer language. The pre-compiler is further arranged to search, in the block(s) of embedded code, for an expression including a main variable intended to contain a string of characters, an indicator variable intended to contain an integer, and one or more predefined characters for association of the main and indicator variables, and to replace each expression found by code in the main computer language providing the N first characters of the first variable, N being the value of the indicator variable.

### CROSS-REFERENCE TO RELATED APPLICATIONS

This application claims priority to French Patent Application No. 1855695, filed on Jun. 26, 2018, the entire content of which is incorporated herein by reference in its entirety.

### FIELD

The present invention relates to a pre-compiler, a system for developing a program, a pre-compilation method and a corresponding computer program.

The invention applies more particularly to a pre-compiler of the type designed to:
analyze a source code comprising main code written in a main computer language and at least one block of code written in another computer language embedded in the main code, and
replace each block of embedded code by replacement code in the main computer language.

### BACKGROUND

The company MICROFOCUS markets a software suite comprising a pre-compiler (also called “pre-processor”) called OpenESQL of the aforementioned type, in which the main computer language is the language COBOL and each block of embedded code is an embedded SQL instruction, from which an SQL instruction intended for a database is intended to be deduced.

Yet, Oracle databases support indicator variables. An indicator variable is a variable added after a main variable, after the sign “:”, and indicating the number of first characters of the main variable that are used. Thus, if the main variable can contain 32 characters but only the first 10 are used (the others being for example spaces), the indicator variable will have the value 10. This allows the database to only use a variable having a length of 10 to store the main variable.

It may be desired to provide a pre-compiler that allows to use the indicator variables for any type of database.

### SUMMARY

An aspect of the invention is therefore a pre-compiler of the aforementioned type, adapted to:
search, in the block(s) of embedded code, for an expression comprising:
   a main variable intended to contain a string of characters,
   an indicator variable intended to contain an integer, and
   one or more predefined characters for association of the main and indicator variables, and
replace each expression found by code in the main computer language providing the N first characters of the first variable, N being the value of the indicator variable.

Thanks to the invention, the indicator-variable expression is replaced by code in the main language allowing the use of the indicator variable by any database. Thus, the N first characters contained in the main variable are sent to the database, instead of the expression of predefined form comprising the indicator variable, such that any database can understand what is sent. In other words, the interpretation of the expression of predefined form and the processing of the character string of the main variable which results from this interpretation, that were previously performed in the database, are, in the invention, performed by the computer program that sends the result, such that the database doesn't need to be designed to perform this interpretation and this processing.

In particular, in an embodiment, there is provided a non-transitory computer readable medium comprising a pre-compiler including machine readable instructions arranged to:
analyze a source code comprising:
   main code written in a main computer language, and
   at least one instruction embedded in the main code, written in another computer language and intended for a database possibly comprising an expression of predefined form comprising:
      a first variable, corresponding to a main variable, defined in the main code to contain a string of characters,
      a second variable, corresponding to an indicator variable, defined in the main code to contain an integer number N that indicates the number of first characters contained in the main variable that are to be used by the database, and
      one or more predefined characters for association of the main and indicator variables, and
   replace each embedded instruction by replacement code in the main computer language arranged, when it is compiled by a compiler and executed by a computer, to send to the database an instruction deduced from the embedded instruction,
   search the expression of predefined form in each embedded instruction, and
   replace each expression of predefined form found by code in the main computer language arranged, when it is compiled by a compiler and executed by a computer, to provide the N first characters contained in its main variable, such that these N first characters replace, in the deduced instruction sent to the database, the expression of predefined form found.

Optionally, each expression for which a search is carried out has the form A: B, where A is the main variable and B the indicator variable.

Also optionally, the code providing the N first characters of the main variable has the form A(1:B), where A is the main variable and B is the indicator variable.

Also optionally, the pre-compiler is further designed to, before the search for the expression in the block(s) of embedded code:
search, in the block(s) of embedded code, for a variable defined in the code in the computer language as having a variable length,
replace each variable having a variable length found by an indicator-variable expression comprising:
   a main variable intended to contain a string of characters,
   an indicator variable intended to contain an integer, and
   the predefined character(s) for association of the main and indicator variables.

Also optionally, the pre-compiler is adapted to detect the presence of a predefined keyword in a definition of a variable in order to determine that this variable has a variable length.

Also optionally, the main computer language is the language COBOL.

Also optionally, each block of embedded code is an embedded SQL instruction.

An aspect of the invention is also a system for developing a program intended to communicate with a set of at least one database each adapted to receive SQL instructions, comprising:
an interface intended to be connected to each database of the set,
a software library,
a pre-compiler according to the invention,
   wherein the replacement code comprises a call to a routine of the software library passing, to the routine, an instruction resulting from the block of embedded code, in order to provide a pre-compiled source code,
   wherein the pre-compiled source code is intended to be compiled by a compiler in order to provide an executable program comprising the call(s) to the routine, wherein the executable program and the routine called are intended to be executed by a computer device,
   wherein the routine called is designed to send, to the interface, a message comprising the instruction passed with the call, and
   wherein the interface is designed to relay, as an SQL instruction, the instruction of at least one of the received message(s) to at least one database of the set.

Optionally, the interface is a server intended to be connected to a computer network to which the computer device is connected and of which the routine is a client.

Also optionally, the interface is adapted to:
maintain a list of the database(s) of the set to each of which the interface has relayed an instruction of one of the message(s) received from the routine, requesting access to this database,
analyze each message received from the routine in order to determine whether the instruction of this message is a predefined instruction, and
if the instruction of this message is the predefined instruction, implement a procedure of logging of the database(s) of the list.

Also optionally, the interface is adapted to:
analyze each message received from the routine and determine whether this message comprises, in addition to the instruction, a number representing a maximum number of results,
relay, as an SQL instruction, the instruction of the message received to a database of the set,
receive from this database a response to the SQL instruction comprising results,
filter the results in order to only keep the maximum number of results, and
send to the routine, instead of the response received, a replacement response comprising only the filtered results.

An aspect of the invention is also a pre-compilation method comprising:
the analysis of a source code comprising main code written in a main computer language and at least one block of code written in another computer language embedded in the main code, and
the replacement of each block of embedded code by replacement code in the main computer language,
the search, in the block(s) of embedded code, for an expression comprising:
   a main variable intended to contain a string of characters,
   an indicator variable intended to contain an integer, and
   one or more predefined characters for association of the main and indicator variables, and
the replacement of each expression found by code in the main computer language providing the N first characters of the first variable, N being the value of the indicator variable.

An aspect of the invention is also a computer program that can be downloaded from a communication network and/or is recorded on a non-transitory computer readable medium readable by computer and/or can be executed by a processor, comprising instructions for the execution of the steps of a pre-compilation method according to the invention, when the program is executed on a computer.

### BRIEF DESCRIPTION OF THE DRAWINGS

The invention will be better understood via the following description, given only as an example and made in reference to the appended drawings in which:

FIG. 1 schematically shows the overall structure of a computer facility, according to an embodiment of the invention, and

FIG. 2 illustrates the successive steps of a method for development and use of a program intended to communicate with a set of databases, according to an embodiment of the invention.

### DETAILED DESCRIPTION

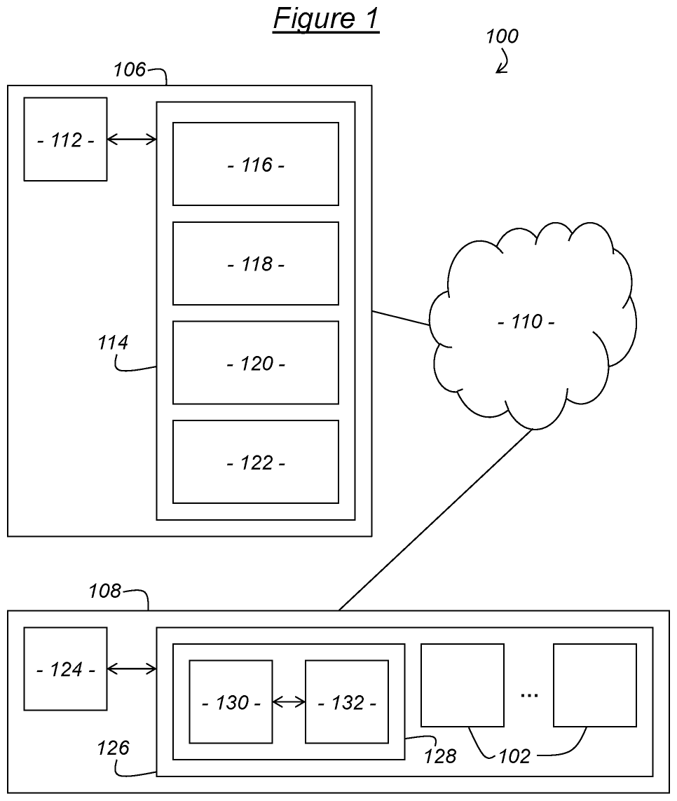

In reference to FIG. 1, a computer facility 100 implementing the invention will now be described.

The computer facility 100 comprises a set of at least one database, designated individually and collectively by the reference 102, and a system for communication with the database(s) 102.

In the present description, the term “database” includes not only the computer structure containing the data, but also the database-management system allowing to manipulate this structure.

Each database 102 is designed to receive SQL (from “Structured Query Language”) instructions. Each database is for example of one of the following types: PostgreSQL, Oracle, MySQL, SQL Server, DB2.

The system for communication with the database(s) 102 comprises a first and a second computer device 106, 108, as well as a computer network 110 to which the first and second computer device 106, 108 are connected, in order to allow them to exchange data. The computer network 110 is for example a TCP/IP network. In particular, the first and second computer device 106, 108 have respective addresses in this computer network 110.

The first computer device 106 comprises a central processing unit 112, such as a microprocessor, and a memory 114 in which a source code 116, a software library 118 comprising at least one routine, called communication routine, a pre-compiler 120 (also called “preprocessor”) and a compiler 122 are recorded.

The source code 116 comprises code in COBOL language and at least one embedded SQL instruction. Each embedded SQL instruction is intended to generate an SQL instruction transmitted to at least one database 102 of the set. In the simplest case, the SQL instruction is identical to the embedded SQL instruction.

The pre-compiler 120 is for example written in C language and can be used on any computer device comprising a COBOL compiler.

In the example described, the first computer device 106 is a mainframe using an operating system of the GCOS family (from “General Comprehensive Operating System”), for example the operating system GCOS 7.

The second computer device 108 comprises a central processing unit 124, such as a microprocessor, and a memory 126 in which a virtual machine 128 (a Java virtual machine in the example described), an interface 130 intended to be executed in the virtual machine 128, and a software library 132 also intended to be executed in the virtual machine 128, when called by the interface 130, are recorded. The interface 130 is thus written in Java language and uses the software library 132 (in the example described, the JDBC library from “Java DataBase Connectivity”) to connect and communicate with each database 102 of the set. The interface 130 is a server of which the communication routine is a client. The interface can thus be used by a plurality of clients. It is therefore reusable by each program in COBOL language developed using the pre-compiler 120.

This makes the development of computer programs easier since developers don't need to have the interface during the computer program's development, but simply the library comprising the routine according to the invention. Furthermore, if there is a need for modifying the interface (for example to support new types of databases), this is made in a transparent way for the computer programs that keep on using the routine communicating according to the client-server mode with the modified interface.

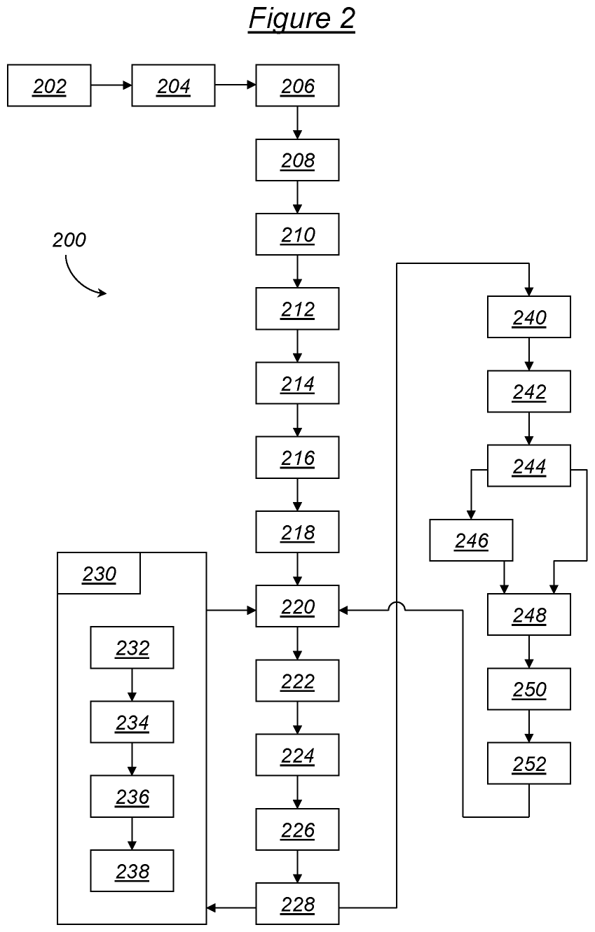

In reference to FIG. 2, a method 200 for development and use of a program intended to communicate with the set of database(s) 102 will now be described.

During a step 202, the pre-compiler 120 obtains the source code 116 comprising the embedded SQL instruction(s). Each embedded SQL instruction is for example found in the source code 116 via at least one predefined expression. For example, each embedded SQL instruction is placed between a predefined start expression (“EXEC SQL” in the example described) and a predefined end expression (“END-EXEC” in the example described).

In a first example, the code in COBOL language of the source code 116 comprises the definition of two variables NAME and ADDRESS (belonging in the example described to a structure called SHOP):

### 01 SHOP.

| | |
|---|---|
| 02 NAME | PIC X(32) VARYING. |
| 02 ADDRESS | PIC X(40) VARYING. |

Moreover, the source code 116 further comprises the embedded SQL instruction:

```
EXEC SQL
    UPDATE _SHOPS_ SET _ADDRESS_ = :ADDRESS
    WHERE _NAME_ = :NAME
END-EXEC.
```

using the two variables NAME and ADDRESS.

In this first example, the variables NAME and ADDRESS are defined as having a variable length because of the presence of a predefined keyword (“VARYING”) at the end of the definition.

In a second example, the source code 116 comprises the following embedded SQL instruction:

```
EXEC SQL
    AT MYDB ALTER TABLE SHOPS ADD SHOP_NAME
    CHAR(10)
END-EXEC.
```

This embedded SQL instruction requests to add a column SHOP_NAME, the elements of which can comprise up to ten characters, to the table SHOPS of the database MYDB.

In a third example, the source code 116 comprises the following embedded SQL instruction:

```
    EXEC SQL
        FOR :NB-ROW AT MYDB SELECT SHOP_NAME,
SHOP_TOWN INTO :SHOP-NAME-T, :SHOP-TOWN-T FROM
SHOPS
    END-EXEC.
```

This embedded SQL instruction requests to select the elements the columns SHOP_NAME and SHOP_TOWN in the table SHOPS of the database MYDB, while limiting the results to the number NB-ROW and while recording the response in the variables SHOP-NAME-T and SHOP-TOWN-T. The variables NB-ROW, SHOP-NAME-T and SHOP-TOWN-T are variables defined in the portion in COBOL language of the source code 116, outside of the embedded SQL instruction, as indicated by the two points “:” that precede them.

In a fourth example, the source code 116 comprises the following embedded SQL instruction:

EXEC SQL
COMMIT ALL
END-EXEC

As will be explained below, this fourth embedded SQL instruction aims to carry out a logging of at least one database 102 of the set.

During a step 204, the pre-compiler 120 analyzes the source code 116 in order to search for an embedded SQL instruction. In the example described, the pre-compiler 120 searches for the pair of predefined start and end expressions and deduces therefrom that the code placed between them is an embedded SQL instruction.

During a step 206, the pre-compiler 120 searches for a definition of a variable having a variable length used in at least one embedded SQL instruction found. In the example described, the pre-compiler 120 detects the presence of the predefined keyword (“VARYING”) in the definition of a variable in order to determine that this variable has a variable length.

In the first example above, the pre-compiler 120 thus finds the definition of the variable NAME and the definition of the variable ADDRESS.

During a step 208, the pre-compiler 120 replaces, in the code in COBOL language, each definition of each variable having a variable length found by two definitions of respectively two variables: a first variable called main variable intended to contain a string of characters and a second variable called indicator variable intended to contain an integer number representing the length used of the main variable. For example, if the main variable is a character string of 32 characters and it contains a word of 10 characters followed by 22 spaces, the indicator variable will contain the number 10.

Thus, in the first example above, the definitions of the variables NAME and ADDRESS in the code in COBOL language are replaced by the following definitions: 01 SHOP.

02 NAME.

| | |
|---|---|
| 49 NAME-LEN | COMP-2. |
| 49 NAME-ARR | PIC X(32) |

02 ADDRESS.

| | |
|---|---|
| 49 ADDRESS-LEN | COMP-2. |
| 49 ADDRESS-ARR | PIC X(40) |

Still during the step 208, the pre-compiler 120 further replaces, in each embedded SQL instruction using it, each variable having a variable length found by an indicator-variable expression comprising the associated main and indicator variables and one or more predefined characters for association of the main and indicator variables. The indicator-variable expression has for example the form A:B, where A is the main variable and B is the indicator variable.

Thus, in the first example above, the variables NAME and ADDRESS are respectively replaced by NAME-ARR:NAME-LEN and ADDRESS-ARR:ADDRESS-LEN, in such a way that the embedded SQL instruction becomes:

```
EXEC SQL
    UPDATE _SHOPS_ SET _ADDRESS_ =
    :ADDRESS-ARR:ADDRESS-LEN
    WHERE _NAME_ = :NAME-ARR:NAME-LEN
END-EXEC.
```

During a step 210, the pre-compiler 120 again analyzes the source code 116 as modified in step 208 in order to search for an indicator-variable expression in the embedded SQL instruction(s).

During a step 212, the pre-compiler 120 replaces each indicator-variable expression found by a replacement expression in COBOL language providing the N first characters of the main variable, N being the value of the indicator variable. In the example described, the replacement expression is A(1:B) where A is the main variable and B the indicator variable.

Thus, in the first example above, the expression ADDRESS-ARR:ADDRESS-LEN is replaced by the expression ADDRESS-ARR(1:ADDRESS-LEN) and the expression NAME-ARR:NAME-LEN is replaced by the expression NAME-ARR(1:NAME-LEN), in such a way that the embedded SQL instruction becomes:

```
EXEC SQL
    UPDATE _SHOPS_ SET _ADDRESS_ =
    :ADDRESS-ARR(1:ADDRESS-LEN)
    WHERE _NAME_ = :NAME-ARR(1:NAME-LEN)
END-EXEC.
```

Thus, the pre-compiler 120 gives the developer writing the source code 116 the choice to either directly use indicator-variable expressions in the embedded SQL instructions (processed in the steps 210 and 212) or use, in the embedded SQL instructions, variables having a variable length (processed in the steps 206 and 208, then in the steps 210 and 212). Thus, the pre-compiler 120 provides design flexibility to the developer.

During a step 214, the pre-compiler 120 replaces each embedded SQL instruction found (as well as the predefined start and end expressions surrounding it) by replacement code in COBOL language.

The replacement code comprises first of all a first portion defining a data structure, called SQL-IO-PARAMETERS in the example described. The data structure SQL-IO-PARAMETERS comprises a first variable, called SQL-REQUEST in the example described, of the type string of characters and intended to contain an instruction resulting from the embedded SQL instruction. The data structure SQL-IO-PARAMETERS further comprises a second variable, called SQL-FOR-VALUE in the example described, intended to contain an argument of a FOR clause of the embedded SQL instruction. The data structure SQL-IO-PARAMETERS further comprises a third variable, called SQL-AT-VALUE in the example described, intended to contain an argument of an AT clause of the embedded SQL instruction.

The replacement code further comprises a second portion intended to deduce an instruction from the embedded SQL instruction and to record this deduced instruction in the variable SQL-REQUEST. In the example described, the deduced instruction corresponds to the embedded SQL instruction without the FOR, AT and INTO clauses. It will be appreciated that, in the example described, if the embedded SQL instruction does not comprise a FOR, AT or INTO clause, the deduced instruction is identical to the embedded SQL instruction.

In the first example above, the second portion of the replacement code is:

```
STRING
    “UPDATE _SHOPS SET _ADDRESS=”
    ADDRESS-ARR(1:ADDRESS-LEN)
    “ WHERE_NAME=”
    NAME-ARR(1:NAME-LEN)
    DELIMITED BY SIZE INTO SQL-REQUEST
END-STRING,
```

Thus, the SQL instruction: UPDATE_SHOPS SET_ADDRESS=ADDRESS-ARR(1:ADDRESS-LEN) WHERE_NAME=NAME-ARR(1:NAME-LEN) is recorded in the variable SQL-REQUEST.

In the second example above, the second portion of the replacement code is:

```
STRING
    “ALTER TABLE SHOPS ADD SHOP_NAME CHAR(10)”
    DELIMITED BY SIZE INTO SQL-REQUEST
END-STRING,
```

Thus, the SQL instruction: ALTER TABLE SHOPS ADD SHOP_NAME CHAR(10) is recorded in the variable SQL-REQUEST.

In the third example above, the second portion of the replacement code is:

```
STRING
    “SELECT SHOP_NAME, SHOP_TOWN ”
    “FROM SHOPS”
    DELIMITED BY SIZE INTO SQL-REQUEST
END-STRING,
```

Thus, the SQL instruction: SELECT SHOP_NAME, SHOP_TOWN FROM SHOPS is recorded in the variable SQL-REQUEST.

In the fourth example above, the second portion of the replacement code is:

```
STRING
    “COMMIT ALL”
    DELIMITED BY SIZE INTO SQL-REQUEST
END-STRING,
```

Thus, the SQL instruction: COMMIT ALL is recorded in the variable SQL-REQUEST.

The replacement code further comprises a third portion intended to record the arguments of the FOR and AT clauses in the respective variables SQL-FOR-VALUE and SQL-AT-VALUE.

In the first and fourth example above, the third portion of the replacement code is empty since there is no FOR clause or AT clause.

In the second example above, the third portion of the replacement code is:

MOVE “MYDB” TO SQL-AT-VALUE,

In the third example above, the third portion of the replacement code is:

MOVE NB-ROW TO SQL-FOR-VALUE,

MOVE “MYDB” TO SQL-AT-VALUE,

The replacement code further comprises a fourth portion comprising a call to the communication routine of the software library 118 passing the variable SQL-REQUEST in which the instruction extracted and the variables SQL-FOR-VALUE and SQL-AT-VALUE in which are recorded, if necessary, the arguments of the FOR and AT clauses are recorded.

In the example described, the structure SQL-IO-PARAMETERS is passed to the call of the communication routine in order to pass the variables SQL-REQUEST, SQL-FOR-VALUE and SQL-AT-VALUE.

In the four examples above, the fourth portion of the replacement code is the following (the communication routine having in the example described the name SQL-CALL):

CALL “SQL-CALL” USING SQL-IO-PARAMETERS,

If an INTO clause is present in the embedded SQL instruction, the replacement code further comprises a fifth portion intended to record a response to the embedded SQL instruction in the variables indicated by the INTO clause.

Thus, in the first, second and fourth example above, there is no INTO clause, in such a way that the replacement code does not comprise the fifth portion.

In the third example above, the fifth portion of the replacement code is intended to record the results for the column SHOP NAME in the variable SHOP-NAME-T and the results for the column SHOP TOWN in the variable SHOP-TOWN-T.

During a step 216, the pre-compiler 120 provides a pre-compiled source code, which is entirely in COBOL language.

During a step 218, the compiler 122 compiles the pre-compiled source code in order to provide an executable program composed of machine code. This executable program comprises in particular the call(s) to the communication routine of the software library 118 having replaced the embedded SQL instruction(s).

During a step 220, the first computer device 106 executes the executable program.

During a step 222, the first computer device 106 reaches, in the executable program, machine code resulting from the compilation of the replacement code of an embedded SQL instruction. Thus, in particular, the communication routine (fourth portion of the replacement code) is called and the deduced instruction is passed to it as well as, if necessary, the arguments of the FOR and AT clauses (contained in the variables SQL-FOR-VALUE and SQL-AT-VALUE).

During a step 224, the communication routine sends to the interface 130, via the computer network 110, a message comprising the deduced instruction and, when applicable, the arguments of the FOR and AT clauses. Thus, the message is sent to the address of the interface 130 in the computer network 110.

During a step 226, the interface 130 receives the message sent by the communication routine and analyzes it.

During a step 228, the interface 130 determines whether the deduced instruction contained in the received message is the predefined instruction: COMMIT ALL. If this is the case, the method 200 continues to the step 230, otherwise it continues to the step 240.

During a step 230, the interface 130 intercepts the deduced instruction contained in the received message and implements a procedure of logging the database(s) 102 belonging to a list kept up to date by the interface 130 and listing the database(s) that the executable program has accessed. A database 102 that the executable program has accessed is a database 102 to which the interface 130 has transmitted at least one SQL instruction resulting from an embedded SQL instruction that has been replaced in the source code of the executable program. In the example described, the logging procedure comprises the steps 232 to 238.

During a step 232, the interface 130 sends, to each database 102 of the list, a first replacement SQL instruction requesting to prepare a logging. In the example described, the first replacement SQL instruction is the instruction SQL: PREPARE TO COMMIT.

During a step 234, each database 102 of the list receives the first SQL instruction, prepares for the logging and sends a response indicating that this database 102 is ready to implement the logging.

During a step 236, the interface 130 receives, from each database 102 of the list, the response indicating that this database 102 is ready to implement the logging.

During a step 238, after the reception of the responses of all the databases 102 of the list, the interface 130 sends, to each database 102 of the list, a second replacement SQL instruction requesting to implement the logging. In the example described, the second replacement SQL instruction is the instruction SQL: COMMIT. The method 200 then returns to step 220.

During a step 240, the interface 130 determines whether the received message comprises, in addition to the deduced instruction that it contains, a variable containing an argument of a FOR clause.

During a step 242, the interface 130 relays, as an SQL instruction, the deduced instruction contained in the received message to the database 102 indicated by the argument of the AT clause.

During a step 244, this database 102 receives the SQL instruction, processes it and, when applicable, sends to the interface 130 a response to the SQL instruction comprising results classified in a certain order.

If the interface 130 has determined in step 240 that the received message comprises, in addition to the extracted instruction, an argument of a FOR clause, then the method 200 continues to the following step 246. Otherwise, it continues to step 248.

During a step 246, the interface 130 intercepts the response to the SQL instruction, filters the results in order to only keep the maximum number indicated by the argument of the FOR clause, and sends to the communication routine, instead of the intercepted response, a replacement response comprising only the filtered results. The results kept are the first according to the order of classification. The method 200 then continues to step 248.

During a step 248, the interface 130 relays the response (with all the results or only a portion according to whether or not step 246 has been executed) to the communication routine.

During a step 250, the communication routine receives the response and makes it available to the program.

During a step 252, when applicable, machine code corresponding to the fifth portion of the replacement code is executed in such a way that the program again calls the communication routine in order for the latter to assign the response to the variables indicated by the INTO clause. The method 200 then returns to step 220.

It is clear that the pre-compiler 120 allows to use the indicator variables for any type of database.

Moreover, it is noted that the invention is not limited to the embodiments described above. It is clear to a person skilled in the art that various modifications can be made to the embodiments described above, in light of the teaching that has just been disclosed to them.

For example, the pre-compilation and the compilation could be carried out on a computer device other than the first computer device 106. The executable program obtained and the software library 118 would then be recorded in the memory 114 of the first computer device 106 in order to be executed.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus.

A computer storage medium can be, or can be included in, a computer-readable storage device, a computer-readable storage substrate, a random or serial access memory array or device, or a combination of one or more of them. Moreover, while a computer storage medium (e.g. a memory) is not a propagated signal, a computer storage medium can be a source or destination of computer program instructions encoded in an artificially-generated propagated signal. The computer storage medium also can be, or can be included in, one or more separate physical components or media (e.g., multiple CDs, disks, or other storage devices). The operations described in this specification can be implemented as operations performed by a data processing apparatus on data stored on one or more computer-readable storage devices or received from other sources.

The term “programmed processor” encompasses all kinds of apparatus, devices, and machines for processing data, including by way of example a programmable processor, digital signal processor (DSP), a computer, a system on a chip, or multiple ones, or combinations, of the foregoing. The apparatus can include special purpose logic circuitry, e.g., an FPGA (field programmable gate array) or an ASIC (application-specific integrated circuit).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., an LCD (liquid crystal display), LED (light emitting diode), or OLED (organic light emitting diode) monitor, for displaying information to the user and a keyboard and a pointing device, e.g., a mouse or a trackball, by which the user can provide input to the computer. In some implementations, a touch screen can be used to display information and to receive input from a user. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

In the detailed presentation of the invention made above, the terms used must not be interpreted as limiting the invention to the embodiments disclosed in the present description, but must be interpreted to include all the equivalents, the providing of which is within the reach of a person skilled in the art by applying their general knowledge art to the implementation of the teaching that has just been disclosed thereto.

1. A non-transitory computer readable medium comprising a pre-compiler including machine readable instructions arranged to:
analyze a source code comprising:
main code written in a main computer language, and
at least one instruction embedded in the main code, written in another computer language and intended for a database possibly comprising an expression of predefined form comprising:
a first variable, corresponding to a main variable, defined in the main code to contain a string of characters,
a second variable, corresponding to an indicator variable, defined in the main code to contain an integer number N that indicates the number of first characters contained in the main variable that are to be used by the database, and
one or more predefined characters for association of the main and indicator variables, and
replace each embedded instruction by replacement code in the main computer language arranged, when it is compiled by a compiler and executed by a computer, to send to the database an instruction deduced from the embedded instruction,
search the expression of predefined form in each embedded instruction, and
replace each expression of predefined form found by code in the main computer language arranged, when it is compiled by a compiler and executed by a computer, to provide the N first characters contained in its main variable, such that these N first characters replace, in the deduced instruction sent to the database, the expression of predefined form found.

2. The non-transitory computer readable medium according to claim 1, wherein each expression of predefined form for which a search is carried out has the form A:B, where A is the main variable, B the indicator variable and the two points the predefined character for association of the main variable A and the indicator variable B.

3. The non-transitory computer readable medium according to claim 1, wherein the code arranged for providing the N first characters contained in the main variable has the form A(1:B), where A is the main variable and B is the indicator variable.

4. The non-transitory computer readable medium according to claim 1, wherein the machine readable instructions are further arranged to, before the search for the expression of predefined form in each embedded instruction:
search, in the main code, a definition of a variable of variable length used in a least one embedded instruction, and
for each variable of variable length a definition of which has been found:
replace the definition found by:
a definition of a main variable intended to contain a string of characters, and
a definition of an indicator variable intended to contain an integer number that indicates the number of first characters contained in the main variable that are to be used by the database,
replace, in each embedded instruction, the variable of variable length by the expression of predefined form comprising:
the main variable defined for this variable of variable length,
the indicator variable defined for this variable of variable length, and
the predefined character(s) for association of the main and indicator variables.

5. The non-transitory computer readable medium according to claim 4, wherein the machine readable instructions are further arranged to detect the presence of a predefined keyword in a definition of a variable in order to determine that this variable has a variable length.

6. The non-transitory computer readable medium according to claim 1, wherein the main computer language is the language COBOL.

7. The non-transitory computer readable medium according to claim 6, wherein the other computer language is the SQL language and wherein each embedded instruction is an embedded SQL instruction.

8. A development and interfacing IT system for executing a computer program, comprising:
a non-transitory computer readable medium including a pre-compiler according to claim 7, wherein the replacement code comprises a call to a routine, said call passing to the routine the SQL instruction deduced from the embedded SQL instruction, in order to provide a pre-compiled source code,
a compiler adapted to compile the pre-compiled source code in order to provide the computer program,
a software library, comprising the called routine, wherein the latter is adapted to send a message containing the deduced SQL instruction,
an interface adapted to receive the message and relay the deduced SQL instruction contained in the received message to the database which belongs to a set of at least one database.

9. The system according to claim 8, wherein the interface is a server intended to be connected, via a computer network, to a computer device for executing the computer program and each call to the routine that it contains, and wherein the routine is a client of said server.

10. The system according to claim 8, wherein the interface is adapted to:
maintain a list of the database(s) of the set to each of which the interface has relayed an instruction of one of the message(s) received from the routine, requesting access to the database,
analyze each message received from the routine in order to determine whether the deduced SQL instruction of the message is a predefined instruction, and
when the instruction of the message is the predefined instruction, implement a procedure of logging of the database(s) of the list.

11. The system according to claim 8, wherein the interface is adapted to:
analyze each message received from the routine and determine whether the message comprises, in addition to the deduced SQL instruction, a number representing a maximum number of results,
after having relayed the SQL instruction deduced from the message received to a database of the set, receive from this database a response to the deduced SQL instruction comprising results,
filter the results in order to only keep the maximum number of results, and
send to the routine, instead of the response received, a replacement response comprising only the filtered results.

12. A pre-compilation method comprising:
analyzing a source code comprising:
main code written in a main computer language, and
at least one instruction embedded in the main code, written in another computer language and intended for a database, possibly comprising an expression of predefined form comprising:
a first variable, corresponding to a main variable, defined in the main code to contain a string of characters,
a second variable, corresponding to an indicator variable, defined in the main code to contain an integer number N that indicates the number of first characters contained in the main variable that are to be used by the database, and
one or more predefined characters for association of the main and indicator variables, and
replacing each embedded instruction by replacement code in the main computer language arranged, when it is compiled by a compiler and executed by a computer, to send to the database an instruction deduced from the embedded instruction,
searching the expression of predefined form in each embedded code, and
replacing each expression of predefined form found by code in the main computer language arranged, when it is compiled by a compiler and executed by a computer, to provide the N first characters contained in its main variable, such that the N first characters replace, in the deduced instruction sent to the database, the expression of predefined form found.

13. A non-transitory computer readable medium comprising a computer program readable by a computer and/or executable by a processor, and comprising instructions for the execution of the steps of a pre-compilation method according to claim 12, when said computer program is executed on a computer.
